(19) United States
(12) Patent Application Publication
(10) Pub. No.: US 2020/0182110 A1
(43) Pub. Date: Jun. 11, 2020

(54) METHOD FOR DIAGNOSING STICKING OF LUBRICATION CONTROL VALVE OF HYBRID VEHICLE

(71) Applicants: Hyundai Motor Company, Seoul (KR); Kia Motors Corporation, Seoul (KR)

(72) Inventors: Young Jun LEE, Seoul (KR); Woul Sun CHOI, Hwaseong-si (KR); Ho Sun JANG, Chungcheongnam-do (KR); Tae Hyung KOO, Seoul (KR)

(21) Appl. No.: 16/402,033

(22) Filed: May 2, 2019

(30) Foreign Application Priority Data
Dec. 10, 2018 (KR) 10-2018-0158181

(51) Int. Cl. F01M 11/10; B60W 20/50; B60W 10/06; B60W 10/08; F16N 29/00

(52) U.S. Cl. CPC F01M 11/10; B60W 20/50; B60W 10/06; B60W 10/08; F16N 29/00; B60W 2710/06; F01M 2250/00; B60W 2540/12; B60W 2520/10; B60W 2510/0638; B60W 2510/081; B60W 2540/16; F01M 2250/66; B60W 2710/081

(57) ABSTRACT

In a hybrid vehicle, a hybrid type lubrication control valve which is a solenoid valve type turned on/off by electricity is used as a lubrication system component for circulating lubricating oil to a transmission and an engine clutch. A method for diagnosing sticking of a lubrication control valve of a hybrid vehicle includes measuring a drag torque acting on an input shaft of the transmission through an output shaft of the motor by measuring a first drag torque in an off-state of the independent type lubrication control valve and a second drag torque in an on-state thereof; and determining whether or not the independent type lubrication control valve is stuck, on the basis of a torque difference between the first drag torque and the second drag torque. The method can diagnose a stuck state of the hybrid type lubrication control valve using motor speed control, before starting the vehicle.

### CROSS REFERENCE TO RELATED APPLICATION

The present application claims priority to Korean Patent Application No. 10-2018-0158181, filed Dec. 10, 2018, the entire contents of which is incorporated herein for all purposes by this reference.

### BACKGROUND

### Field

The present disclosure relates to a method of diagnosing sticking of a lubrication control valve of a hybrid vehicle.

### Description of the Related Art

Generally, in one example of hybrid vehicles, a power transmission device includes an engine and a motor which are connected in series, an engine clutch provided between the engine and the motor and transmitting or blocking engine power, and an automatic transmission converting power into driving wheel and output.

In addition, a lubrication system including an oil pump and an oil supply line for circulating lubrication oil is connected to the transmission and the engine clutch.

The foregoing is intended merely to aid in the understanding of the background of the present invention. And, Applicant does not admit that any information contained in this section constitutes prior art.

### SUMMARY

One aspect of the present invention provides a method of diagnosing sticking of a lubrication control valve of a hybrid vehicle. The method can allow sticking of an independent type lubrication control valve which is turned on/off by electricity to be diagnosed using motor speed control, before starting the vehicle, thereby protecting an engine clutch and a clutch in a transmission from being damaged.

Another aspect of the present invention provides a method of diagnosing sticking of a lubrication control valve of a hybrid vehicle, the method including:

by a transmission control unit (TCU), determining driving intent of a driver and requesting a hybrid control unit (HCU) for diagnosing sticking of an independent type lubrication control valve; determining, by the HCU, whether or not to permit a sticking diagnosis request of the TCU; ordering, by the HCU, motor speed control to a motor control unit (MCU) for controlling motor speed at a predetermined speed, after permitting the sticking diagnosis; driving, a motor at the predetermined speed by the motor speed control of the MCU; measuring, by the TCU, a drag torque acting on an input shaft of the transmission through an output shaft of the motor, by measuring a first drag torque in an off-state of the independent type lubrication control valve TQ1 and a second drag torque in an on-state thereof TQ2; and determining, by the TCU, whether or not the independent type lubrication control valve is stuck, on the basis of a torque difference ΔT between the first drag torque TQ1 and the second drag torque TQ2.

When the TCU receives a brake pedal stroke-off signal, a P-stage signal, a signal with a current vehicle speed of zero, engine speed of zero, and motor speed of zero, the TCU may determine that the driver does not intend to drive and request the HCU for the sticking diagnosis of the independent type lubrication control valve.

In addition, when the TCU is in a normal state possible to diagnose sticking and there is no sticking diagnosis during one driving cycle of the vehicle, the TCU may request the HCU for the sticking diagnosis of the independent type lubrication control valve.

Here, the HCU may permit the sticking diagnosis for the independent type lubrication control valve in an engine clutch non-learning state.

In addition, after permitting sticking diagnosis, the HCU may control the engine to be forcibly turned off when engine starts before the motor speed control order is issued.

In the determining whether or not the independent type lubrication control valve is stuck, the TCU may compare the torque difference ΔT between the first drag torque TQ1 and the second drag torque TQ2 with a reference value, and then when the torque difference ΔT is equal to or higher than the reference value, the TCU may output that the independent type lubrication control valve is in a normal state.

In the determining whether or not the independent type lubrication control valve is stuck, after comparing the torque difference ΔT between the first drag torque TQ1 and the second drag torque TQ2 with the reference value, when the torque difference ΔT is less than reference value, the TCU may output that the independent type lubrication control valve is in a stuck and failed state.

Embodiments of the present invention provide following effects.

First, it is possible to easily diagnose whether the independent type lubrication control valve for controlling lubricating oil supply to the transmission and engine clutch is in a stuck state or not.

Second, when the independent type lubrication control valve is determined to be in the stuck state, the engine clutch can be protected by limiting slip driving thereof with a warning to guide maintenance, and burnout of the clutch in the transmission can be prevented or minimized.

### BRIEF DESCRIPTION OF THE DRAWINGS

The above and other aspects, features and other advantages of the present invention will be more clearly understood from the following detailed description when taken in conjunction with the accompanying drawings, in which:

FIG. 1 is a block diagram showing a power train system of a hybrid vehicle.

FIG. 2 is a block diagram showing a control configuration for diagnosing sticking of a lubrication control valve of the hybrid vehicle.

FIG. 3 is a flowchart showing a process for diagnosing sticking of the lubrication control valve of the hybrid vehicle.

### DETAILED DESCRIPTION OF EMBODIMENTS

Hereinbelow, embodiments of the present invention will be described in detail with reference to the accompanying drawings. Throughout the drawings, the same reference numerals will refer to the same or like parts.

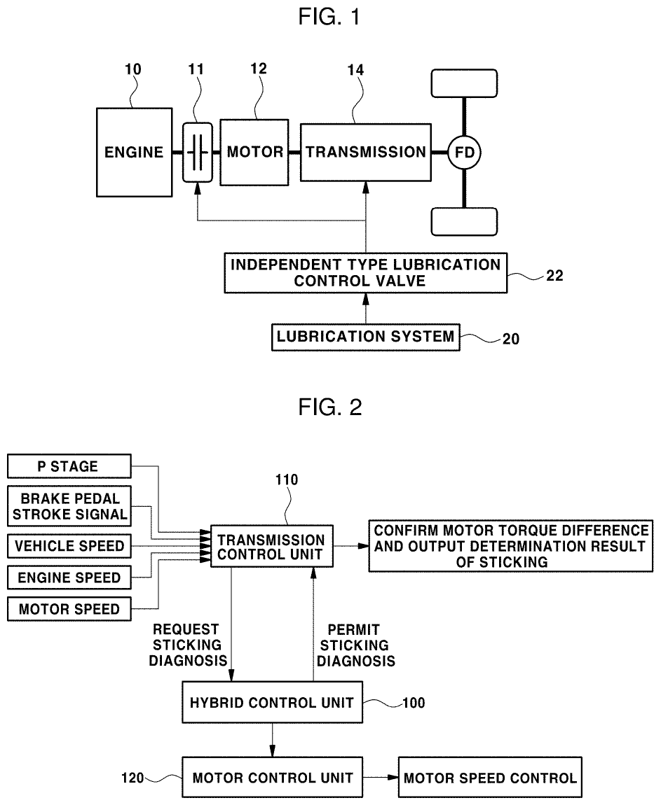

Referring to FIG. 1, a power transmission device for hybrid vehicles is configured as an engine 10 and a motor 12 which are connected in series, an engine clutch 11 provided between the engine 10 and the motor 12 and transmitting or blocking engine power, and an automatic transmission 14 transmitting power to wheels.

In addition, a lubrication system 20 including an oil pump and an oil supply line for circulating lubrication oil is connected to the transmission 14 and the engine clutch 11.

Particularly, the oil supply line of the lubrication system 20 further has an independent type lubrication control valve 22, in embodiments, in addition to an existing lubrication control valve.

In order to increase in motor usage and to enlarge range of slip driving of the engine clutch, the independent type lubrication control valve 22 adopts the solenoid type valve that can be turned on/off, independently.

Therefore, by on-operation of the independent type lubrication control valve 22, the additional lubrication can be freely provided regardless of gear positions while it was possible that additional lubrication is supplied to the transmission and the engine clutch at a first gear stage.

In one of lubrication control valves, by using a fail-safe logic, it can be indirectly determined whether the valve works or not, or whether the valve is stuck or not due to inability of gear shifting. However, in the independent type lubrication control valve 22, it would be hard to determine whether it is stuck or not.

In embodiments, sticking means an inoperative state where the solenoid type valve cannot physically move due to failure, when a control current is applied thereto.

Accordingly, when the sticking of independent type lubrication control valve is generated, the engine clutch or the clutch in the transmission lacks lubrication, thereby suffering engine clutch burnout or wear of the clutch in the transmission.

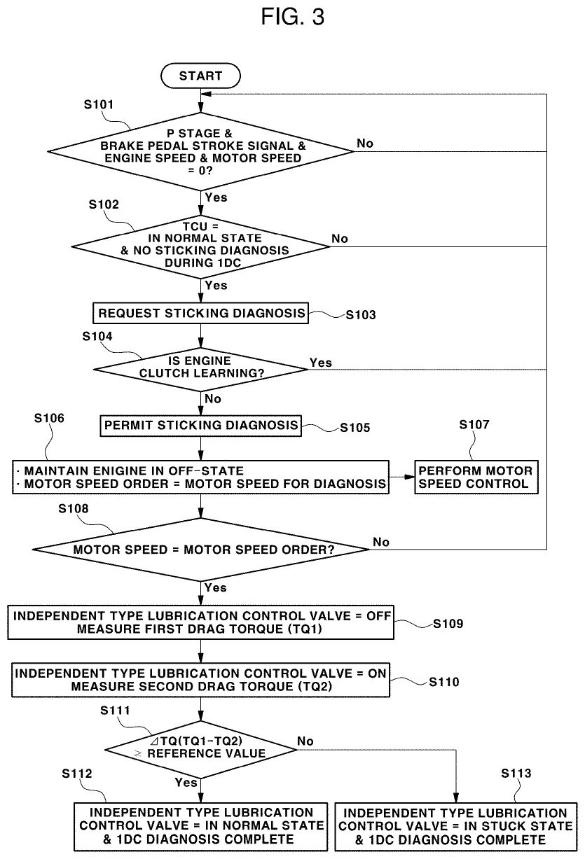

Accompanying FIG. 2 is a block diagram showing a control configuration for diagnosing sticking of a lubrication control valve of a hybrid vehicle according to embodiments of the present invention, and FIG. 3 is a flowchart showing a process for diagnosing sticking of the lubrication control valve of the hybrid vehicle according to embodiments of the present invention.

As shown in FIG. 2, diagnosing sticking of a lubrication control valve according to embodiments of the present invention is operated by cooperative control between a transmission control unit (TCU) 110, a hybrid control unit (HCU) 100 which is an upper rank control unit, and a motor control unit (MCU) 120.

The TCU 110 determines driving intention of a driver, on the basis of a brake pedal stroke signal, a current gear state, a current vehicle speed, an engine speed, and a motor speed.

In addition, when the TCU 110 receives a brake pedal stroke-off signal in a state in which a driver does not step on a brake pedal, a P-stage signal that is a current gear stage, a signal that is a current vehicle speed of zero, an engine speed of zero, and a motor speed of zero, the TCU 110 determines that the driver does not intend to drive and requests the HCU 100 for the diagnosing sticking of an independent type lubrication control valve.

In addition, when the TCU 110 is in a normal state in which it is possible to diagnose sticking and there is no sticking diagnosis during one driving cycle (1 DC) of the vehicle, the TCU 110 requests the HCU 100 for the sticking diagnosis of the independent type lubrication control valve.

When the TCU 110 request the sticking diagnosis, the HCU 100 permits the sticking diagnosis for the independent type lubrication control valve depending on whether a learning engine clutch is operated or not.

For reference, processes of correcting friction coefficient of the clutch in consideration of degradation and abrasion due to aging of the engine clutch, or of correcting a gap regarding change of reaction force of a return spring for clutch operation are engine clutch learning, and the engine clutch learning operation is performed in an ignition key starting on-state and an idle-state before starting the vehicle, for example.

In embodiments, the HCU 100 permits the sticking diagnosis for the independent type lubrication control valve in a non-learning engine clutch state so as to prioritize the learning operation of the engine clutch.

In addition, after permitting sticking diagnosis of the independent type lubrication control valve, when the engine is started, the HCU 100 forcibly turns off the engine for practical diagnosis and orders motor speed control to the MCU 120 to control motor speed at a predetermined speed.

Therefore, since the MCU 120 performs the motor speed control depending on the motor speed control order of the HCU 100, the motor is driven at the predetermined speed.

In embodiments, a drag torque acting on an input shaft of the transmission passing through an output shaft of the motor is measured by the TCU 110 in on and off states of the independent type lubrication control valve, respectively.

Specifically, the TCU 110, measures a first drag torque TQ1 acting on the input shaft of the transmission passing through the output shaft of the motor, in an off-state of the independent type lubrication control valve, and then measures a second drag torque TQ2 acting on the input shaft of the transmission passing through the output shaft of the motor, in an on-state of the independent type lubrication control valve.

Then, the TCU 110 calculates a torque difference ΔT between the first drag torque TQ1 which is measured in the off-state of the independent type lubrication control valve of the solenoid type valve and the second drag torque TQ2 which is measured in the on-state thereof, and then compares the torque difference ΔT with a reference value.

In embodiments, when the torque difference ΔT is equal to or higher than the reference value, the TCU 110 determines that the independent type lubrication control valve normally performs on/off operation and outputs to a dashboard that the independent type lubrication control valve is in a normal state.

As the independent type lubrication control valve is turned on and additional lubrication is normally generated from a lubrication system to a perturbation system of the transmission, the drag torque acting on the input shaft of the transmission may be decreased. In contrast, as the independent type lubrication control valve is turned off and the additional lubrication is not generated from the lubrication system to the perturbation system of the transmission, the drag torque acting on the input shaft of the transmission may be increased. Accordingly, when the torque difference ΔT is equal to or higher than the reference value, the TCU 110 may determine that the independent type lubrication control valve is operated normally.

However, when the torque difference ΔT is less than the reference value, the TCU 110 determines that the independent type lubrication control valve is stuck, and outputs to the dashboard that the independent type lubrication control valve is in a failure state.

Referring to FIGS. 2 and 3, sequence of the sticking diagnosis of the independent type lubrication control valve according to embodiments of the present invention is as follows.

First, the TCU 110 determines the driving intention of the driver on the basis of the brake pedal stroke signal, the current gear state, the current vehicle speed, the engine speed, and the motor speed (S101).

Here, when the TCU 110 receives the brake pedal stroke-off signal in a state in which the driver does not step on the brake pedal, the P-stage signal that is the current gear stage, the signal with the current vehicle speed of zero, the engine speed of zero, and the motor speed of zero, the TCU 110 determines that the driver does not intend to drive.

Then, the TCU 110 self-checks whether or not to be in the normal state in which it is possible to diagnose sticking and also confirms that there is no sticking diagnosis during the one driving cycle (1 DC) of the vehicle (S102). Then, when the TCU 110 is in the normal state possible to diagnose sticking and there is no sticking diagnosis during the one driving cycle of the vehicle, the TCU 110 requests the HCU 100 for the sticking diagnosis of the independent type lubrication control valve (S103).

When there is the sticking diagnosis request of the TCU 110, the HCU 100 confirms whether the engine clutch performs the learning operation or not (S104) and permits the sticking diagnosis of the independent type lubrication control valve in the engine clutch non-learning state (S105).

When the engine is started and operating, the HCU 100 forcibly turns off the engine for practical diagnosis of the independent type lubrication control valve, and orders the speed control to the MCU 120 to control the motor speed at a predetermined speed (S106).

Accordingly, the MCU 120 performs the motor speed control for controlling the motor at the predetermined speed depending on the motor speed control order of the HCU 100 (S107).

Then, after confirming that the motor speed is maintained in accordance with the motor speed control order (S108), the HCU 100 orders the TCU 110 to determine whether the independent type lubrication control valve is stuck or not.

Next, when the motor is driven at the predetermined speed by the motor speed control of the MCU, the TCU 110 measures the drag torque acting on the input shaft of the transmission through the output shaft of the motor, by measuring the drag torque in the on and off states of the independent type lubrication control valve, respectively.

In embodiments, the TCU 110 measures the first drag torque TQ1 acting on the input shaft of the transmission through the output shaft of the motor, in a state in which the independent type lubrication control valve is turned off (S109), and measures the second drag torque TQ2 acting on the input shaft of the transmission through the output shaft of the motor, in a state in which the independent type lubrication control valve is turned on (S110).

Next, the TCU 110 calculates the torque difference ΔT between the first drag torque TQ1 measured in the off-state of the independent type lubrication control valve of the solenoid type valve and the second drag torque TQ2 measured in the on-state of the independent type lubrication control valve of the solenoid type valve, and then compares the torque difference ΔT with the reference value (S111).

In embodiments, when the torque difference ΔT is equal to or higher than the reference value, the TCU 110 determines that the independent type lubrication control valve performs the on/off operation normally and outputs to the dashboard that the independent type lubrication control valve is in the normal state (S112).

However, when the torque difference ΔT is less than the reference value, the TCU 110 determines that the independent type lubrication control valve is stuck and outputs to the dashboard that the independent type lubrication control valve is in the failure state (S113).

According to the embodiments discussed above, when it is determined that the independent type lubrication control valve is stuck, the driver can be informed of the failure state of the independent type lubrication control valve through the dashboard and be guided to repair the independent type lubrication control valve. In addition, the engine clutch can be protected by limiting slip driving of the engine clutch while driving to a service center, and clutch burnout in the transmission can be prevented, avoided or minimized.

Although embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of diagnosing sticking of a lubrication control valve of a hybrid vehicle, the method comprising:
by a transmission control unit (TCU), determining driving intention of a driver and requesting a hybrid control unit (HCU) to diagnose sticking of an independent type lubrication control valve;
determining, by the HCU, whether or not to permit a sticking diagnosis request of the TCU;
ordering, by the HCU, motor speed control to a motor control unit (MCU) for controlling motor speed at a predetermined speed, after permitting the sticking diagnosis;
driving a motor at the predetermined speed by the motor speed control of the MCU;
measuring, by the TCU, a drag torque acting on an input shaft of the transmission through an output shaft of the motor by measuring a first drag torque in an off-state of the independent type lubrication control valve and a second drag torque in an on-state thereof; and
determining, by the TCU, whether or not the independent type lubrication control valve is stuck, on the basis of a torque difference between the first drag torque and the second drag torque.

2. The method of claim 1, wherein, when the TCU receives a brake pedal stroke-off signal, a P-stage signal, a signal with a current vehicle speed of zero, an engine speed of zero, and a motor speed of zero, the TCU determines that the driver has no intention of driving and requests the HCU for the sticking diagnosis of the independent type lubrication control valve.

3. The method of claim 1, wherein, when the TCU is in a normal state possible to diagnose sticking and there is no sticking diagnosis during one driving cycle of the vehicle, the TCU requests the HCU for the sticking diagnosis of the independent type lubrication control valve.

4. The method of claim 1, wherein the HCU permits the sticking diagnosis of the independent type lubrication control valve in a non-learning engine clutch state.

5. The method of claim 1, wherein, after permitting sticking diagnosis, the HCU controls an engine to be forcibly turned off when the engine starts before the motor speed control order is issued.

6. The method of claim 1, wherein, in the determining whether or not the independent type lubrication control valve is stuck, the TCU compares the torque difference between the first drag torque and the second drag torque with a reference value, and then when the torque difference is equal to or higher than the reference value, the TCU outputs that the independent type lubrication control valve is in a normal state.

7. The method of claim 1, wherein, in the determining whether or not the independent type lubrication control valve is stuck, the TCU compares the torque difference between the first drag torque and the second drag torque with a reference value, and then when the torque difference is less than reference value, the TCU outputs that the independent type lubrication control valve is in a stuck and failed state.
